(19) United States
(12) Patent Application Publication
(10) Pub. No.: US 2025/0341285 A1
(43) Pub. Date: Nov. 6, 2025

(54) OPTIMIZED FILLING OF CRYOGENIC TANKS

(71) Applicant: L'Air Liquide, Societe Anonyme pour l'Etude et l’Exploitation des Procedes Georges Claude, Paris (FR)

(72) Inventor: Wassim OUAKRIM, Paris (FR)

(21) Appl. No.: 19/197,680

(22) Filed: May 2, 2025

(30) Foreign Application Priority Data
May 3, 2024 (FR) FRFR2404644

(51) Int. Cl. F17C 5/02; B64F 1/28

(52) U.S. Cl. CPC F17C 5/02; B64F 1/28; F17C 2221/012; F17C 2223/033; F17C 2250/0408; F17C 2250/043; F17C 2265/032; F17C 2265/065; F17C 2270/0189

(57) ABSTRACT

A method for filling a cryogenic liquid receiving tank, the method using a movable source tank and a towing vehicle, the method being carried out in a distribution site comprising a first zone for parking the source tanks and the towing vehicle, and a second zone, distinct from the first zone, for filling the receiving tank, the first zone comprising a depressurization zone and a waiting zone distinct from the depressurization zone, the method comprising the steps of moving the source tank, transferring a quantity of cryogenic liquid from the source tank to the receiving tank and, preferably, simultaneously transferring a quantity of boil-off gas present in the receiving tank to the source tank, moving the source tank to the first zone, verifying at least one parking condition of the source tank.

### CROSS REFERENCE TO RELATED APPLICATIONS

This application claims the benefit of priority under 35 U.S.C. § 119 (a) and (b) to French patent application No. FR2404644, filed May 3, 2024, which is herein incorporated by reference in its entirety.

### FIELD OF THE INVENTION

This invention relates to a system and a method for filling cryogenic tanks.

### BACKGROUND OF THE INVENTION

A cryogenic liquid is produced at a production site, potentially transported to storage sites, and then distributed to users at distribution sites. Most frequently, the production site comprises tanks for storing the produced cryogenic liquid, from which movable tanks to be used to distribute the cryogenic liquid are filled. The cryogenic liquid is sometimes transported to storage sites, where the movable tanks to be used for distribution are filled.

At distribution sites, a receiving tank is filled with the cryogenic liquid contained in the movable tank coming from the production site or the storage site. The storage site can thus also be considered to be a distribution site. Hereinafter, source tank is understood to mean any movable cryogenic liquid tank from which a receiving tank is filled, and receiving tank is understood to mean any fixed or movable cryogenic liquid tank filled with cryogenic liquid drawn from a source tank.

In some cases, cryogenic liquid consumption is so high that many source and receiving tanks have to be managed at distribution sites. This is the case, notably, for cryogenic liquids used as fuels. The distribution sites then have to be able to manage a plurality of source tanks and a plurality of receiving tanks, while optimizing filling procedures and ensuring the safety of equipment and people. When cryogenic liquid is a fuel, there is also the problem of preventing, or at least limiting, greenhouse gas emissions, notably caused by venting the boil-off gases contained in the tanks.

Examples of distribution sites notably include vehicle fuel tank filling sites, such as land vehicle fuel filling stations, railway stations and airports, and boat and ship fuel tank filling sites.

The desire to use liquid hydrogen as a fuel, in order to meet the challenges of climate change, brings particular constraints related to its characteristics and its use. The main problems that arise are related to the cryogenic nature of the liquid hydrogen and the holding time for tanks, notably movable tanks, of cryogenic liquids. The heat entering the tanks causes some of the cryogenic liquid to evaporate and generate evaporation or boil-off gas (BOG). Over time, the generation of this boil-off gas decreases the level of cryogenic liquid in the tank, and increases the pressure and temperature of the cryogenic liquid. This can make it difficult to ensure that receiving tanks are filled under good conditions, i.e. under thermodynamic conditions allowing the exploitation and use of the maximum quantity of cryogenic liquid, ideally all of it.

In the particular case of vehicle filling sites, and notably airports, it is probably not possible, for safety reasons, to depressurize the receiving tank (for example of an aircraft, a car, a truck, a train) or the source tank at the same place where the filling operations are carried out (for example, on the tarmac at the airport, or in the parking area for cars or trucks, or in a railway station). To avoid this problem, it is known to provide a dedicated zone for the depressurization operations.

It is also known to use a network of distribution pipes, instead of source tanks, to distribute the cryogenic liquid and recover the boil-off gases. An example is described in G. D. Brewer's study “LH₂ Airport requirements study”, published by NASA in 1976. These systems are expensive to build and allow little flexibility during their operation.

It is also known, for vehicle fuel tanks, to replace an empty tank with a full tank. These solutions require the use of a greater number of tanks and the provision of dedicated tank exchange sites, which are more complicated to manage than filling sites.

### SUMMARY OF THE INVENTION

In certain embodiments, the present invention is intended to propose a method and a system for filling cryogenic liquid tanks which overcomes all or some of the drawbacks mentioned above.

The invention notably relates to a method for filling a cryogenic liquid receiving tank, notably a liquid cryogenic fuel tank of a receiving vehicle, the cryogenic liquid notably being liquid hydrogen. The method uses a movable source tank and a towing vehicle. The method is carried out in a distribution site comprising a first zone for parking the source tanks and the towing vehicle and a second zone, distinct from the first zone, for filling the receiving tank.

The first zone comprises a depressurization zone and a waiting zone distinct from the depressurization zone.

The method comprises the following steps.
moving the source tank from the first zone to the second zone using the towing vehicle;
transferring a quantity of cryogenic liquid from the source tank to the receiving tank and, preferably, simultaneously transferring a quantity of boil-off gas present in the receiving tank to the source tank;
moving the source tank from the second zone to the first zone using the towing vehicle; and
verifying at least one parking condition of the source tank. If the at least one parking condition is met, parking the source tank in the depressurization zone. If the at least one parking condition is not met, parking the source tank in the waiting zone.

The invention may advantageously be used for filling fixed or movable receiving tanks, notably semi-trailers for transporting liquefied gas, or on-board cryogenic fuel tanks. The fluids in question are for example helium, hydrogen, methane, natural gas, or any other fluid or mixture of fluids at cryogenic temperatures.

According to other aspects, the embodiments of the invention may have one or more of the following features.

In one embodiment, the method comprises, when the source tank is parked in the depressurization zone, a step of recovering the vapour phase of the cryogenic liquid contained in the source tank and, preferably, a step of transferring the recovered vapour phase to at least one of: a gas distribution network, a fixed or mobile gas storage tank, a vehicle filling station, a liquefaction or reliquefaction plant, a vent.

In one embodiment, the method comprises a step of estimating the depressurization time required to recover the vapour phase.

In one embodiment, the at least one parking condition is selected from: the liquid level in the source tank is below a predetermined liquid level threshold, the pressure in the source tank is above a predetermined pressure threshold; the temperature in the source tank is above a predetermined temperature threshold, the waiting time before the next need to fill a receiving vehicle is above a predetermined waiting time threshold.

In one embodiment, the verification step comprises, in order, the following sub-steps.
verifying that the liquid level in the source tank is below a predetermined liquid level threshold;
verifying that the pressure in the source tank is above the predetermined pressure threshold, and/or that the temperature of the cryogenic liquid in the source tank is above the predetermined temperature threshold;
verifying that the waiting time before the next need to fill a receiving tank is above a predetermined waiting time threshold; and.
if at least one of these conditions is met, the source tank is parked in the depressurization zone.

In one embodiment, the predetermined pressure threshold and/or the predetermined temperature threshold are defined or calculated using predetermined tables and/or a model in such a way as to allow optimum filling of the receiving tank, notably in consideration of the permissible thermodynamic limits in the receiving tank.

In one embodiment, if the liquid level in the source tank is below the predetermined liquid level threshold, the vapour phase is recovered until the pressure in the source tank is below a determined acceptance threshold.

In one embodiment, if the liquid level in the source tank is at or above the predetermined liquid level threshold, and if the pressure in the source tank is above the predetermined pressure threshold and/or the temperature of the cryogenic liquid in the source tank is above the predetermined temperature threshold, the vapour phase is recovered until the pressure in the source tank is below the predetermined pressure threshold and/or the temperature in the source tank is below the predetermined temperature threshold.

In one embodiment, the method is carried out within the perimeter of an airport and/or the receiving tank is a cryogenic liquid tank of an aircraft.

The invention also relates to a system for filling a cryogenic liquid receiving tank, notably a liquid cryogenic fuel tank of a receiving vehicle, the cryogenic liquid notably being liquid hydrogen, the system comprising a plurality of movable source tanks designed to contain a liquid phase and a vapour phase of the cryogenic liquid, at least one towing vehicle designed to move one of the movable source tanks, a first zone for parking the source tanks and the towing vehicle or vehicles, a second zone located close to and distinct from the first zone, for transferring a quantity of cryogenic liquid contained in one of the source tanks to the receiving tank.

The first zone comprises a recovery member for recovering the vapour phase of the cryogenic liquid and a set of pipes designed to establish a fluidic connection between the recovery member and at least one of the source tanks.

The recovery member is preferably designed to be fluidically connectable to at least one of: a gas distribution network, a fixed or movable gas storage tank, a vehicle filling station, a liquefaction or reliquefaction plant, a vent.

According to other aspects, the embodiments of the invention may have one or more of the following features.

In one embodiment, the set of pipes comprises at least a first pressure and/or flow control member designed to be opened when the pressure in the source tank is above a determined acceptance threshold, for example in consideration of liquid cryogenic fuel production conditions, to enable the vapour phase of the cryogenic liquid to be recovered by the recovery member.

In one embodiment, the set of pipes comprises at least a second pressure control member designed to be opened when the pressure in the source tank is above the predetermined pressure threshold and/or the temperature in the source tank is above the predetermined temperature threshold, the predetermined pressure threshold and the predetermined temperature threshold being determined, for example, in consideration of tank filling conditions of the receiving vehicle, to enable the vapour phase of the cryogenic liquid to be recovered by the recovery member.

In one embodiment, the towing vehicle comprises circuitry designed to establish a fluidic connection between one of the source tanks and the receiving tank, in order to transfer the quantity of cryogenic liquid.

The invention also relates to an airport comprising a filling system according to one of the embodiments described.

The invention may also relate to any alternative device or process comprising any combination of the features above or below, notably within the scope of the claims.

### BRIEF DESCRIPTION OF THE DRAWINGS

The invention will be understood better from reading the following description and from studying the accompanying figures. These figures are given only by way of illustration and do not in any way limit the invention.

FIG. 1 is a schematic partial view of a first example of a filling method according to the invention,

FIG. 2 is a schematic partial view of a second example of a filling method according to the invention,

FIG. 3 is a schematic partial view illustrating a first example of a filling system according to the invention,

FIG. 4 is a schematic partial view illustrating a second example of a filling system according to the invention,

FIG. 5 is a schematic partial view illustrating a possible example embodiment of the parking zone according to the invention.

### DETAILED DESCRIPTION OF THE INVENTION

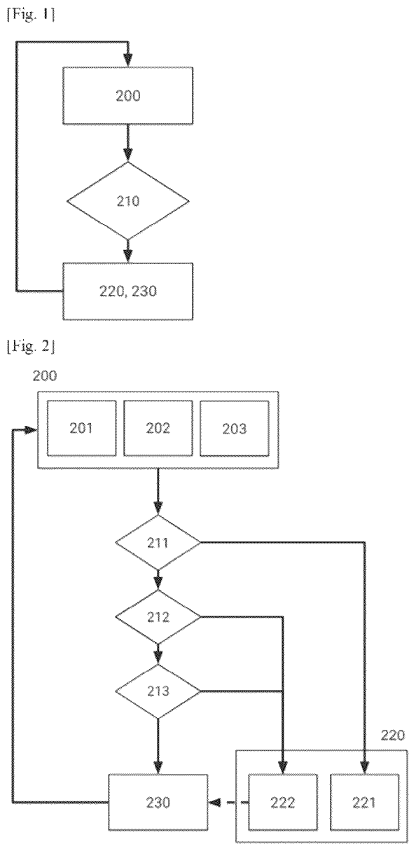

The filling method shown schematically in FIG. 1 is used to fill a cryogenic liquid receiving tank 11, 12, 13, 14 and uses a movable source tank 21, 22, 23 and a towing vehicle 30. The source tanks and the receiving tanks are typically designed to contain a liquid phase and a vapour phase of the cryogenic liquid.

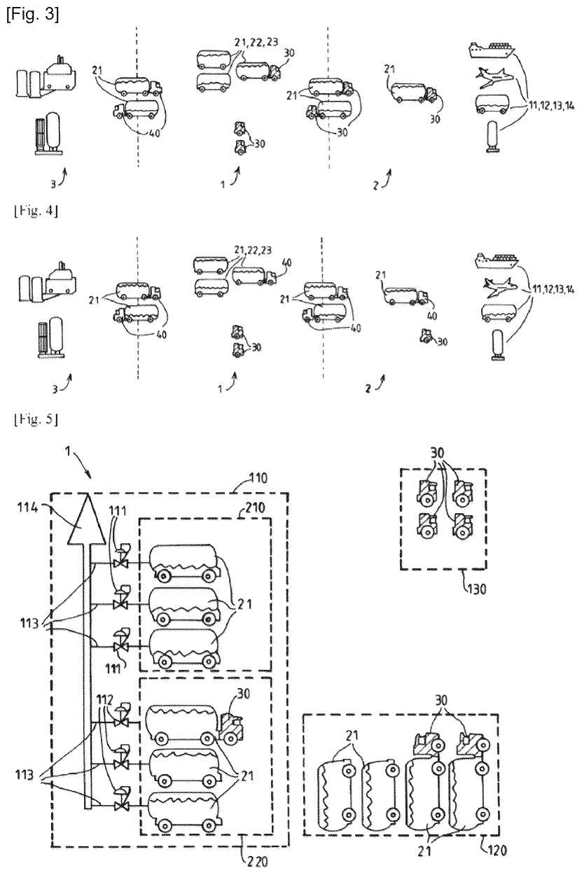

The method may be carried out, for example, as shown in FIG. 3, FIG. 4 and/or FIG. 5, in a distribution site comprising a first zone 1 for parking the source tanks 21, 22, 23 and the towing vehicle 30 and a second zone 2, distinct from the first zone 1, for filling the receiving tank 11, 12, 13. The first zone 1 comprises a depressurization zone 110 and a waiting zone 120 distinct from the depressurization zone 110.

The first zone 1 is notably intended to accommodate full source tanks coming from a production or storage site 3, which may be more than 100 km from the distribution site. This distance will depend on the characteristics of the cryogenic liquid to be distributed. In the case of liquid hydrogen, this distance is typically of the order of 200 km.

The first zone 1 is also intended to accommodate the empty or partially empty source tanks following the operations of filling the receiving tanks.

The second zone 2 is intended to accommodate the receiving tanks, and the operations of filling the receiving tank take place here. Within the distribution site, the second zone 2 is separated from the first zone 1. For example, the users or owners of the receiving tanks only have access to the second zone 2 and not to the first zone 1.

The source tank may be one of a plurality of source tanks 21, 22, 23 used to transport the cryogenic liquid from the production or storage site 3 to the distribution site. The source tank is a movable tank and is preferably mounted on a semi-trailer towed by a motorized vehicle 40. The source tank can also be installed directly on a motorized vehicle.

The towing vehicle 30 may be the same motorized vehicle 40 used to tow one of the source tanks 21, 22, 23 from the production or storage site 3 to the distribution site. The towing vehicle 30 may also be a dedicated motorized vehicle 30, which is permanently on the distribution site.

Within the first zone 1, the towing vehicle 30 can be coupled and remain coupled to a source tank, or it can be uncoupled and parked separately from the source tanks.

The method comprises a distribution step 200.

More precisely, the method comprises a step 201 of moving the source tank 21, 22, 23 from the first zone 1 to the second zone 2 using the towing vehicle 30.

The method comprises a step 202 of transferring a quantity of cryogenic liquid from the source tank 21, 22, 23 to the receiving tank 11, 12, 13, 14. During the transfer step 202, a quantity of boil-off gas present in the receiving tank 11, 12, 13, 14 is preferably simultaneously transferred to the source tank 21, 22, 23.

The method comprises a step 203 of moving the source tank 21, 22, 23 from the second zone 2 to the first zone 1 using the towing vehicle 30.

The method comprises a step of verifying at least one parking condition 210 of the source tank 21, 22, 23: if the at least one parking condition 210 is met, the source tank is parked in the depressurization zone 110; if the at least one parking condition 210 is not met, the source tank 21, 22, 23 is parked in the waiting zone 120.

Thus, when a source tank 21, 22, 23 arrives in the first zone 1, its state is evaluated and the source tank is positioned so as to optimize both the evolution of its state and the future filling of receiving tanks 11, 12, 13, 14.

In one embodiment, when the source tank is parked in the depressurization zone 110, the method comprises a step 220 of recovering the vapour phase of the cryogenic liquid contained in the source tank 21, 22, 23. The method preferably also comprises a step of transferring the recovered vapour phase to at least one of the following handling means: a gas distribution network, a fixed or movable gas storage tank, a vehicle filling station, a liquefaction or reliquefaction plant, a vent.

Preferably, the vent is used only when none of the other vapour phase handling means is available. In all other cases, the method enables the vapour phase to be recovered and reused. The release of potentially hazardous or greenhouse gases into the atmosphere is also avoided.

In one embodiment, the method comprises a step of estimating the depressurization time required to recover the vapour phase. This makes it possible, if necessary, to decide whether the towing vehicle 30 should remain coupled to the source tank 21, 22, 23. For example, if the estimated depressurization time is long, the towing vehicle 30 will be uncoupled and will be able to be used with another source tank 21, 22, 23. This may be the case notably when the estimated depressurization time is greater than the waiting time between two successive fills or uses of the towing vehicle 30. Depending on the case, this average waiting time can vary between thirty minutes and six hours. Typically, the waiting time can be of the order of one hour. The management of the distribution site and the various filling operations can thus be optimized. The number of towing vehicles required can be reduced.

In one embodiment, the at least one parking condition 210 is selected from the following.
the liquid level 211 in the source tank is below a predetermined liquid level threshold;
the pressure 212 in the source tank is above a predetermined pressure threshold;
the temperature 212 in the source tank is above a predetermined temperature threshold;
the waiting time 213 before the next need to fill a receiving vehicle 11, 12, 13, 14 is above a predetermined waiting time threshold.

The predetermined liquid level threshold 211 may, for example, correspond to a minimum quantity of liquid required to completely fill a receiving tank. If the liquid level in the source tank 21, 22, 23 is below this threshold, the tank can be earmarked for return to the production or storage site 3 for refilling. If necessary, the source tanks 21, 22, 23 having a liquid level below the threshold can be parked in a dedicated zone. This optimizes the management of the distribution site and reduces waiting times for filling a receiving tank.

In the case of an airport, for example, it may be desirable for the receiving tank of an aircraft to be filled only from a single source tank. This reduces the time the aircraft remains on the ground.

The predetermined pressure or temperature thresholds 212 may, for example, correspond to limit or safety values. If the pressure or temperature in the source tank exceeds these thresholds, the cryogenic liquid is no longer under thermodynamic conditions favourable to its use and/or its holding in the receiving tank. This makes it possible to guarantee that the cryogenic liquid will be delivered under acceptable thermodynamic conditions.

Furthermore, safety risks may arise if these thresholds are exceeded. The method thus makes it possible to detect and react to potentially dangerous situations.

The predetermined pressure and/or temperature thresholds 212 may depend on the construction of the source tank and/or the receiving tank. This means, for example, that these thresholds may vary depending on the shape, dimensions and/or materials of the tank. The predetermined pressure threshold may for example be between 2 bar and 6 bar. The predetermined temperature threshold may for example be between 22 K and 28 K.

The predetermined waiting time threshold 213 may for example be defined in consideration of the characteristics of the source tank and of the estimated evolution of the thermodynamic conditions of the cryogenic liquid within the source tank.

If the waiting time 213 is short, the source tank can, for example, remain coupled to the towing vehicle and be parked in a dedicated waiting zone 120. This may be the case notably when the estimated waiting time is less than the time required for the cryogenic liquid contained in the tank to reach, and/or exceed, the predetermined temperature threshold and/or the predetermined pressure threshold. A short waiting time is, for example, less than four hours, preferably less than one hour. This optimizes the management of the distribution site and can reduce the time required to fill a receiving tank.

If the waiting time 213 is long, there may for example be a risk of a pressure increase within the source tank 21, 22, 23 as a result of evaporation of the cryogenic liquid. This may be the case notably when the estimated waiting time is greater than the time required for the cryogenic liquid contained in the tank to reach, and/or exceed, the predetermined temperature threshold and/or the predetermined pressure threshold. A long waiting time is, for example, more than four hours. The source tank may for example be uncoupled from the towing vehicle 30 and/or parked in a depressurization zone 110 equipped to manage the pressure within the source tank. This enables the safety of the distribution site to be guaranteed, and thermodynamic conditions favourable to the delivery of the cryogenic liquid can be more easily maintained within the source tank.

In one embodiment, the verification step 210 comprises, in order, the following sub-steps.
a sub-step 211 of verifying that the liquid level in the source tank is below a predetermined liquid level threshold;
a sub-step 212 of verifying that the pressure in the source tank is above the predetermined pressure threshold, and/or that the temperature of the cryogenic liquid 212 in the source tank is above the predetermined temperature threshold; and
a sub-step 213 of verifying that the waiting time before the next need to fill a receiving tank is above a predetermined waiting time threshold.

If at least one of these conditions is met, the source tank 21, 22, 23 is parked in the depressurization zone 110.

The verification step 210 can stop at the first sub-step 211, 212, 213 for which the condition is met. In this case, the subsequent sub-steps are not executed.

If none of the conditions is met, the source tank may for example be parked 230 in the waiting zone 120. The towing vehicle 30 may remain coupled to the source tank 21, 22, 23 and may also be parked in the waiting zone 120. Alternatively, the towing vehicle 30 can be uncoupled from the source tank 21, 22, 23 and parked in a dedicated zone 130 for towing vehicles.

In one embodiment, the predetermined pressure threshold and/or the predetermined temperature threshold are defined or calculated using predetermined tables and/or a model in such a way as to allow optimum filling of the receiving tank, notably in consideration of the permissible thermodynamic limits in the receiving tank.

For example, the predetermined pressure threshold and/or the predetermined temperature threshold may be defined in consideration of the liquid level and/or the pressure and/or temperature expected in the receiving tank when it arrives at the distribution site to be filled. Notably, in the case of filling fuel tanks of an aircraft, one can take into account the thermodynamic conditions in the fuel tank of the aircraft in question when it arrives at the airport.

Alternatively, and notably in the case where the receiving tank is a fixed tank, the predetermined pressure threshold and/or the predetermined temperature threshold may be defined in consideration of the liquid level and/or the pressure and/or temperature expected in the receiving tank when the source tank arrives in the second zone 2 to fill the receiving tank.

The optimum filling of the receiving tank can be defined in consideration of the state of the receiving tank at the end of the filling procedure. Optimum filling therefore means filling that ensures that the thermodynamic state of the receiving tank at the end of the filling procedure is within permissible limits, for example the pressure and/or temperature in the filled receiving tank do not exceed defined maximum values, for example in consideration of the construction of the tank and/or prevailing standards.

The optimum filling of the receiving tank can also be defined in consideration of the state of the receiving tank when a user is about to draw cryogenic liquid. Optimum filling therefore means filling that ensures that the thermodynamic state of the receiving tank is within permissible limits when cryogenic liquid is first drawn by a user following the filling procedure, for example the pressure and/or temperature in the receiving tank do not exceed defined minimum values, for example in consideration of the construction of the tank, the propulsion system of the vehicle and/or the anticipated use of the cryogenic liquid.

In one embodiment, if the liquid level 211 in the source tank is below the predetermined liquid level threshold, the vapour phase is recovered 221 until the pressure in the source tank is below a determined acceptance threshold. This acceptance threshold may depend on the production conditions of the cryogenic liquid, or the thermodynamic parameters of the liquefaction process, notably so that the vapour phase can be recycled into the liquefier, or prevailing road traffic regulations. The acceptance threshold can for example be set at a pressure value between 2 bar and 6 bar.

As explained above, in this case the source tank may have been earmarked for return to the production or storage site 3 in order to be refilled. The acceptance threshold is therefore a maximum permissible pressure threshold in the source tank when it leaves the distribution site to return to the production or storage site 3. For example, the acceptance threshold is defined in consideration of the distance to be travelled and the thermodynamic limits imposed by the production or storage site 3 to agree to fill the source tank.

The method thus ensures that the source tanks can be filled at the production or storage site 3 and guarantees the safety of the tank and the driver during the journey to the production or storage site 3, while enabling the excess boil-off gas to be recovered and possibly reused.

In one embodiment, if the liquid level 211 in the source tank is at or above the predetermined liquid level threshold, and if the pressure 212 in the source tank is above the predetermined pressure threshold and/or the temperature of the cryogenic liquid 212 in the source tank is above the predetermined temperature threshold, the vapour phase is recovered 222 until the pressure in the source tank is below the predetermined pressure threshold and/or the temperature in the source tank is below the predetermined temperature threshold.

In this case, the source tank 21, 22, 23 still contains enough liquid to refill a receiving tank. It is therefore necessary to maintain the pressure and/or the temperature in the source tank at values below the predetermined pressure and temperature thresholds, which are defined in consideration of the filling conditions of the receiving tanks 11, 12, 13, 14.

Thus, the method optimizes the use of the cryogenic liquid contained in the source tanks. The availability of source tanks for filling is also optimized since the waiting time before the next filling can advantageously be used, for example, to depressurize the source tank.

Optionally, the depressurization time required to reach the predetermined pressure and/or temperature threshold can be estimated. If the estimated depressurization time is short and if the waiting time before the next need to fill a receiving tank is below the predetermined waiting time threshold, the source tank can be parked, after the depressurization operation, in the waiting zone 120.

In one embodiment, the method comprises a step of receiving, in the first zone 1, a source tank from a production and/or storage site 3, and a step 210 of verifying that the pressure in said source tank is above a predetermined pressure threshold.

If the pressure 212 is above the predetermined threshold, the source tank that has just arrived at the distribution site is parked in the depressurization zone 110. If the pressure 212 is below the predetermined threshold, the source tank that has just arrived at the distribution site is parked in the waiting zone 120.

The source tank 21, 22, 23 coming from the production or storage site 3 can thus be handled in the same way as a source tank 21, 22, 23 returning from the second zone 2.

In one embodiment, the method is implemented within the perimeter of an airport, or the distribution site is an airport.

In one embodiment, the receiving tank is a cryogenic liquid tank of an aircraft, notably a liquid hydrogen tank on board the aircraft and intended to supply a fuel cell or a combustion reactor.

The invention also relates to a filling system. The filling system shown schematically in FIG. 3, FIG. 4 and FIG. 5 is used to fill a cryogenic liquid receiving tank 11, 12, 13, 14. This receiving tank may notably be a liquid cryogenic fuel tank of a receiving vehicle.

The filling system according to the invention comprises a plurality of movable source tanks 21, 22, 23 designed to contain a liquid phase and a vapour phase of the cryogenic liquid, at least one towing vehicle 30 designed to move one of the movable source tanks, a first zone 1 for parking the source tanks 21, 22, 23 and the towing vehicle or vehicles 30, and a second zone 2 located close to and distinct from the first zone 1, for transferring a quantity of cryogenic liquid contained in one of the source tanks to the receiving tank. The first zone 1 and the second zone 2 thus form part of a single distribution site.

The first zone 1 comprises a recovery member 114 for recovering the vapour phase of the cryogenic liquid and a set of pipes 113 designed to establish a fluidic connection between the recovery member 114 and at least one of the source tanks 21, 22, 23.

The recovery member 114 is preferably designed to be fluidically connectable to at least one of: a gas distribution network, a fixed or movable gas storage tank, a vehicle filling station, a liquefaction or reliquefaction plant, a vent.

The vent may be for example provided for safety reasons. Preferably, more than half, and ideally all, of the vapour phases recovered by the recovery member are conveyed to one of the other means listed above. Thus, the recovered gas can be reused and potential greenhouse gases are prevented from being released into the atmosphere.

In one embodiment, the set of pipes 113 comprises at least a first pressure and/or flow control member 111 designed to be opened when the pressure in the source tank is above a determined acceptance threshold. This acceptance threshold can depend on the production conditions of the cryogenic liquid, or the thermodynamic parameters of the liquefaction process, or prevailing road traffic regulations. The acceptance threshold can for example be set between 2 bar and 6 bar.

The pipes equipped with first pressure control members 111 are intended to be connected to the source tanks which have been earmarked for return to the production or storage site 3.

Preferably, the pipes provided with the first pressure control members 111 are grouped together in a first dedicated sub-zone 210 within the depressurization zone 110.

In one embodiment, the set of pipes 113 comprises at least a second pressure control member 112 designed to be opened when the pressure in the source tank is above the predetermined pressure threshold and/or the temperature in the source tank is above the predetermined temperature threshold. The predetermined pressure threshold and the predetermined temperature threshold are for example determined as described above.

The pipes provided with second pressure control members 112 are intended to be connected to the source tanks which can still be used on the distribution site for filling at least one receiving tank.

Preferably, the pipes provided with the second pressure control members 112 are grouped together in a second dedicated sub-zone 220 within the depressurization zone 110 that is distinct from the first sub-zone 210.

The first and second pressure control members 111, 112 enable the recovery of the vapour phase of the cryogenic liquid by the recovery member 114 to be started or stopped or controlled. The pressure control member may for example be a valve controlled by a sensor that measures the pressure and/or temperature in the source tank, an automatic mechanical device that opens depending on the pressure difference between the pressure in the source tank and the pressure in the recovery member, a valve, a dump valve, a pressure regulator, a flow controller, or any other suitable control member.

The first and second pressure control members 111, 112 can allow the gas that is to be recovered to flow by completely opening or closing the pipe on which they are mounted, this operating mode also being called on/off. The opening of the first and second pressure control members 111, 112 can also be controlled in a variable manner, for example the opening rate can depend on the pressure in the source tank.

In one embodiment, the towing vehicle 30 comprises circuitry designed to establish a fluidic connection between one of the source tanks 21, 22, 23 and the receiving tank, in order to transfer the quantity of cryogenic liquid. This circuitry may for example comprise pipes, valves or other control members, a pumping member, and any other member or equipment required to ensure the transfer of the cryogenic liquid from the source tank to the receiving tank.

In one embodiment, the towing vehicle 30 is designed to be mechanically coupled to the source tanks and to tow them.

The invention also relates to an airport comprising a filling system as described above. Indeed, the invention is particularly suited to optimizing the management of the cryogenic fuel supply of aircraft within the perimeter of an airport.

The invention can also be used to manage the supply of fuel at a filling site for liquid cryogenic fuel tanks of vehicles, such as cars, trucks, trains, ships.

The invention is particularly suited to distributing liquid hydrogen and filling liquid hydrogen tanks.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1. A method for filling a cryogenic liquid receiving tank, notably a liquid cryogenic fuel tank of a receiving vehicle, the cryogenic liquid notably being liquid hydrogen, the method using a movable source tank and a towing vehicle, the method being carried out in a distribution site comprising a first zone for parking the source tanks and the towing vehicle and a second zone, distinct from the first zone, for filling the receiving tank, the first zone comprising a depressurization zone and a waiting zone distinct from the depressurization zone, the method comprising the following steps:
moving the source tank from the first zone to the second zone using the towing vehicle;
transferring a quantity of cryogenic liquid from the source tank to the receiving tank and, preferably, simultaneously transferring a quantity of boil-off gas present in the receiving tank to the source tank;
moving the source tank from the second zone to the first zone using the towing vehicle;
verifying at least one parking condition of the source tank;
upon verification that at least one parking condition is met, parking the source tank in the depressurization zone;
upon verification that at least one parking condition is not met, parking the source tank in the waiting zone.

2. The method according to claim 1, further comprising, when the source tank is parked in the depressurization zone, a step of recovering the vapour phase of the cryogenic liquid contained in the source tank and, preferably, a step of transferring the recovered vapour phase to at least one of: a gas distribution network, a fixed or movable gas storage tank, a vehicle filling station, a liquefaction or reliquefaction plant, a vent.

3. The method according to claim 2, further comprising a step of estimating the depressurization time required to recover the vapour phase.

4. The method according to claim 1, wherein the at least one parking condition is selected from: the liquid level in the source tank is below a predetermined liquid level threshold; the pressure in the source tank is above a predetermined pressure threshold; the temperature in the source tank is above a predetermined temperature threshold; the waiting time before the next need to fill a receiving vehicle is above a predetermined waiting time threshold.

5. The method according to claim 4, wherein the verification step comprises, in order, the following sub-steps:
verifying that the liquid level in the source tank is below the predetermined liquid level threshold;
verifying that the pressure in the source tank is above the predetermined pressure threshold, and/or that the temperature of the cryogenic liquid in the source tank is above the predetermined temperature threshold;
verifying that the waiting time before the next need to fill a receiving tank is above the predetermined waiting time threshold;
and in that if at least one of these conditions is met, the source tank is parked in the depressurization zone.

6. The method according to claim 4, wherein the predetermined pressure threshold and/or the predetermined temperature threshold are defined or calculated using predetermined tables and/or a model in such a way as to allow optimum filling of the receiving tank, notably in consideration of the permissible thermodynamic limits in the receiving tank.

7. The method according to claim 4, wherein, upon a determination that the liquid level in the source tank is below the predetermined liquid level threshold, the vapour phase is recovered until the pressure in the source tank is below a determined acceptance threshold.

8. The method according to claim 4, wherein, upon a determination that the liquid level in the source tank is at or above the predetermined liquid level threshold, and upon a determination that the pressure in the source tank is above the predetermined pressure threshold and/or the temperature of the cryogenic liquid in the source tank is above the predetermined temperature threshold, the vapour phase is recovered until the pressure in the source tank is below the predetermined pressure threshold and/or the temperature in the source tank is below the predetermined temperature threshold.

9. The method according to claim 1, wherein the method is carried out within the perimeter of an airport and/or in that the receiving tank is a cryogenic liquid tank of an aircraft.

10. A system for filling a cryogenic liquid receiving tank, wherein the cryogenic liquid receiving tank is a liquid cryogenic fuel tank of a receiving vehicle, the cryogenic liquid being liquid hydrogen, the system comprising
a plurality of movable source tanks configured to contain a liquid phase and a vapor phase of the cryogenic liquid;
a towing vehicle configured to move one of the plurality of movable source tanks;
a first zone configured for parking the plurality of movable source tanks and the towing vehicle;
a second zone located proximate to and distinct from the first zone, the second zone being configured for transferring a quantity of cryogenic liquid contained in one of the plurality of movable source tanks to the receiving tank,
wherein the first zone comprises a recovery member configured to recover the vapor phase of the cryogenic liquid and a set of pipes configured to establish a fluidic connection between the recovery member and at least one of the plurality of movable source tanks, the set of pipes comprising
at least a first pressure and/or flow control member configured to be opened when the pressure in the source tank is above a determined acceptance threshold, and/or
at least a second pressure control member configured to be opened when the pressure in the source tank is above a predetermined pressure threshold and/or the temperature in the source tank is above a predetermined temperature threshold, the predetermined pressure threshold and the predetermined temperature threshold being determined in consideration of tank filling conditions of the receiving vehicle,
wherein the recovery member is configured to be fluidically connectable to at least one of: a gas distribution network, a fixed or movable gas storage tank, a vehicle filling station, a liquefaction or reliquefaction plant, and a vent in order to enable the vapor phase of the cryogenic liquid to be recovered by the recovery member.

11. The system according to claim 10, wherein the towing vehicle comprises circuitry configured to establish a fluidic connection between one of the source tanks and the receiving tank, in order to transfer the quantity of cryogenic liquid.

12. An airport comprising a filling system according to claim 10.
